(19) United States
(12) Patent Application Publication
(10) Pub. No.: US 2010/0091993 A1
(43) Pub. Date: Apr. 15, 2010

(54) WIRELESS COMMUNICATION DEVICE AND ENCRYPTION KEY UPDATING METHOD

(75) Inventor: Tomohiro Iwama, Yokohama-shi (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/525,504

(22) PCT Filed: Feb. 2, 2007
(86) PCT No.: PCT/JP2007/051791

§ 371 Date: Jul. 31, 2009

(51) Int. Cl. H04L 9/00

(52) U.S. Cl. 380/273

(57) ABSTRACT

Provided are a wireless communication device capable of decoding received data even when receiving the data while the mismatching of an encryption key occurs due to updating of the encryption key; and an encryption updating method for the device. The wireless communication device comprises an encryption unit for encrypting transmission data with an encryption key, a decoding unit for decoding received data with the encryption key, a key replacing unit for generating a new encryption key to update an encryption key to be used in the encryption unit and the decoding unit to the new encryption key, and a key storing unit for storing the encryption key before being updated. The decoding unit decodes a received data with use of the old encryption key stored in the key storing unit when the received data cannot be decoded with use of the newly updated encryption key.

### TECHNICAL FIELD

The present invention relates to a wireless communication apparatus that updates an encryption key and an encryption key updating method thereof, and relates, for example, to a mobile communication terminal apparatus and wireless base station that update an encryption key by means of a 4-way handshake, together with an encryption key updating method thereof.

### BACKGROUND ART

Currently, the 4-Way Handshake shown in Non-Patent Document 1 is generally used as an encryption key updating method in an IEEE802.11 compliant wireless LAN. This method has been adopted by the Wi-Fi Alliance, and a WPA/WPA2-compatible mobile communication terminal apparatus and wireless base station incorporate a 4-way handshake function.

FIG. 1 is a control sequence diagram showing a procedure whereby a mobile communication terminal apparatus and wireless base station update an encryption key (PTK: Pairwise Transient Key) by means of a 4-way handshake. It is assumed that the mobile communication terminal apparatus and wireless base station share a PMK (Pairwise Master Key) that is an item that generates an encryption key (step S0).

First, the wireless base station generates a random number called an ANonce (Authenticator Nonce) (step S1), and transmits the generated ANonce to the mobile communication terminal apparatus (step S2). On receiving the ANonce, the mobile communication terminal apparatus generates a random number called an SNonce (Supplicant Nonce) (step S3). Then the mobile communication terminal apparatus generates a PTK from the generated SNonce, the received ANonce, and a held PMK (step S4), and transmits the generated SNonce to the wireless base station (step S5). On receiving the SNonce, the wireless base station generates a PTK from the generated ANonce, the received SNonce, and a held PMK (step S6), and transmits a PTK installation confirmation message to the mobile communication terminal apparatus (step S7). On receiving the confirmation message, the mobile communication terminal apparatus transmits a PTK installation confirmation message to the wireless base station (step S8), and installs the generated PTK (step S9). On receiving the confirmation message, the wireless base station installs the generated PTK (step S10). By means of the above procedure, a mobile communication terminal apparatus and wireless base station can update their respectively held encryption keys (PTKs) to a common new encryption key (PTK).

However, a problem with an encryption key updating method that uses a 4-way handshake is the temporary occurrence of encryption key mismatching.

That is to say, in FIG. 1, while the wireless communication terminal apparatus installs a new encryption key in step S9, the wireless base station installs the new encryption key in step S10. Therefore, in the interval from step S9 through step S10 (the PTK installation time lag in FIG. 1), the mobile communication terminal apparatus performs encryption or decoding using the new encryption key while the wireless base station performs encryption or decoding using an old encryption key.

If the wireless base station transmits data encrypted with the old encryption key during this PTK installation time lag, the mobile communication terminal apparatus attempts to decode the received encrypted data with the new encryption key, and is therefore unable to decode it. If the mobile communication terminal apparatus is unable to decode received encrypted data, it may judge that a security violation has occurred, and sever the connection to the wireless base station. There is also a possibility of speech, image, or suchlike real-time traffic being interrupted in the mobile communication terminal apparatus, which is perceived by a user as noise. This kind of problem is thought to occur frequently in corporate networks or the like in which a short encryption key updating interval is set in order to maintain security.

A method of solving the above problem is the method described in Non-Patent Document 2 used by an IPSec (IP Security Protocol). In this method, when an apparatus that performs encrypted communication updates an encryption key, the apparatus establishes an encrypted channel that uses a new encryption key in addition to an encrypted channel that uses an old encryption key used theretofore. In this way, an apparatus that performs encrypted communication can handle encryption key mismatching by simultaneously establishing an encrypted channel that uses an old encryption key and an encrypted channel that uses a new encryption key. However, although the method described in Non-Patent Document 2 is effective for IP communication (layer 3) capable of multiplexing channels, it cannot be applied to a wireless LAN (layer 2) that cannot multiplex channels.

Also, in an asynchronous communication system, the method described in Patent Document 1 is a client processing method for use when an error occurs in received data. In this method, when a client apparatus detects the occurrence of a sequence error in received data, the apparatus waits for a predetermined time to receive correctly sequenced data. By this means, a client apparatus can prevent erroneous operation of a client application even if a sequence error is detected in received data. Therefore, Patent Document 1 includes no disclosure concerning a client processing method for a case in which a decoding error occurs in received data.

Patent Document 1: Japanese Patent Application Laid-Open No. 2003-204332

Non-Patent Document 1: IEEE802.11i-2004, p. 85-92, “8.5.3 4-Way Handshake”.

Non-Patent Document 2: RFC2401 “Security Architecture for the Internet Protocol”

### DISCLOSURE OF INVENTION

### Problems to be Solved by the Invention

As described above, a problem with an encryption key updating method that uses a conventional 4-way handshake is that, if data transmission/reception is performed during the occurrence of encryption key mismatching, an apparatus that receives data is unable to decode the received data.

It is an object of the present invention to provide a wireless communication apparatus capable of decoding received data even if data is received during the occurrence of encryption key mismatching, and an encryption key updating method thereof.

### Means for Solving the Problem

A wireless communication apparatus of the present invention has an encryption section that encrypts transmission data to be transmitted to another communication apparatus using an encryption key shared with the other communication apparatus, a decoding section that decodes received data received from the other communication apparatus using the encryption key, a key replacing section that generates a new encryption key shared with the other communication apparatus and updates the encryption key used by the encryption section and the decoding section to the new encryption key, and a key storing section that stores the encryption key prior to updating when the key replacing section updates the encryption key; wherein the decoding section, if unable to decode the received data using the updated new encryption key, decodes that received data using the encryption key stored by the key storing section.

An encryption key updating method of the present invention is an encryption key updating method in a first wireless communication apparatus that encrypts transmission data to be transmitted to a second wireless communication apparatus using an encryption key shared with the second wireless communication apparatus and also decodes received data received from the second wireless communication apparatus using the encryption key; and has a step of generating a new encryption key shared with the second wireless communication apparatus, an updating step of updating the encryption key to the new encryption key, and a step of storing the encryption key used up to the updating step.

### ADVANTAGEOUS EFFECTS OF INVENTION

According to the present invention, in encryption key updating an old encryption key used theretofore is not discarded but stored, and even if data is received during the occurrence of encryption key mismatching, the received data can be decoded using the old encryption key.

### BRIEF DESCRIPTION OF DRAWINGS

FIG. 1 is a control sequence diagram showing a conventional procedure for updating an encryption key by means of a 4-way handshake;

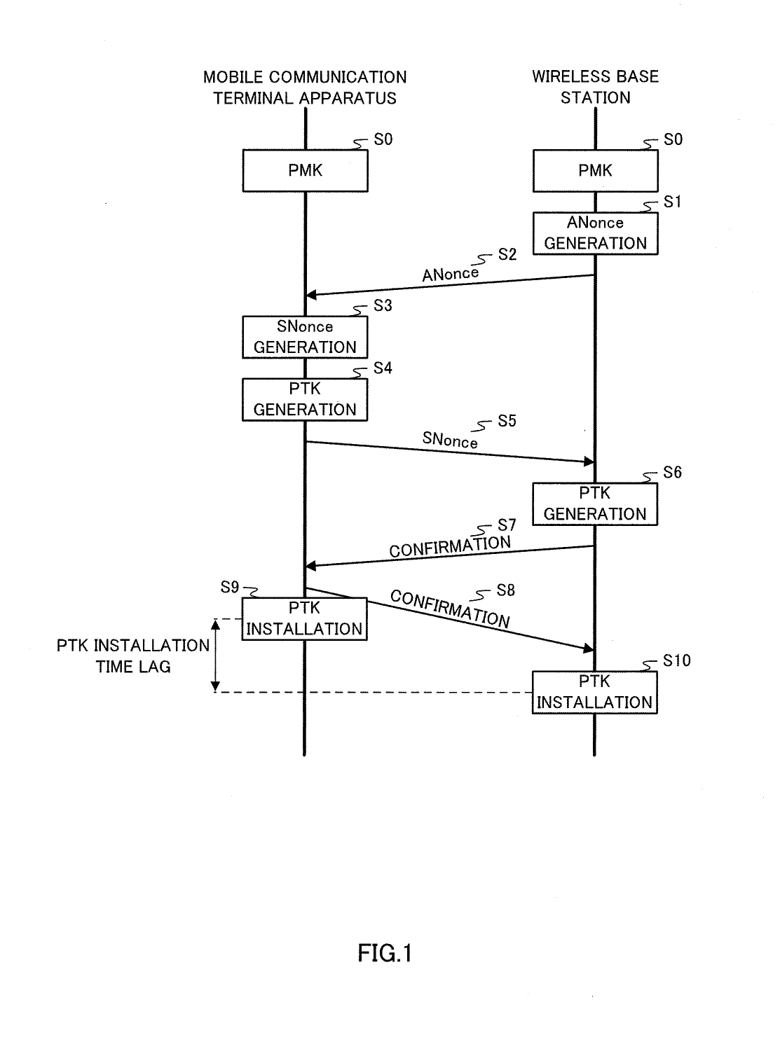

FIG. 2 is a block diagram showing configurations of wireless communication apparatuses (a mobile communication terminal apparatus and a wireless base station) of Embodiment 1 of the present invention;

FIG. 3 is a control sequence diagram showing a procedure used when an encryption key is updated by wireless communication apparatuses (a mobile communication terminal apparatus and a wireless base station) of Embodiment 1 of the present invention;

FIG. 4 is a block diagram showing configurations of wireless communication apparatuses (a mobile communication terminal apparatus and a wireless base station) of Embodiment 2 of the present invention; and

FIG. 5 is a control sequence diagram showing a procedure used when an encryption key is updated by wireless communication apparatuses (a mobile communication terminal apparatus and a wireless base station) of Embodiment 2 of the present invention.

### BEST MODE FOR CARRYING OUT THE INVENTION

Now, embodiments of the present invention will be described in detail with reference to the accompanying drawings.

### Embodiment 1

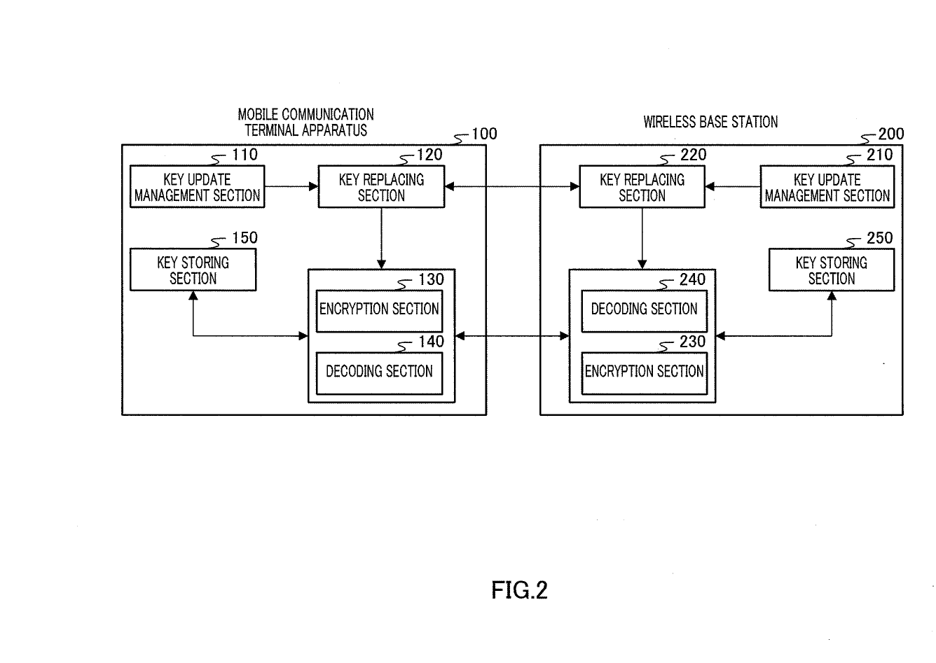

FIG. 2 is a block diagram showing configurations of wireless communication apparatuses according to Embodiment 1 of the present invention. This is an example in which wireless communication apparatuses of this embodiment are applied respectively to mobile communication terminal apparatus 100 and wireless base station 200 configuring a wireless LAN.

Mobile communication terminal apparatus 100 is configured by means of key update management section 110, key replacing section 120, encryption section 130, decoding section 140, and key storing section 150.

Key update management section 110 manages the life-span of encryption keys possessed by encryption section 130 and decoding section 140. On detecting that the life-span of these encryption keys has expired, key update management section 110 instructs key replacing section 120 to perform encryption key updating.

When instructed to perform encryption key updating by key update management section 110, or on receiving a random number (ANonce) for generating an encryption key from wireless base station 200, key replacing section 120 sends a key update start notification indicating the start of encryption key updating to encryption section 130 and decoding section 140, and then generates an encryption key by performing a 4-way handshake with wireless base station 200. After finishing the 4-way handshake, key replacing section 120 notifies encryption section 130 and decoding section 140 of the new encryption key, and has them update to the new key. Also, when a predetermined time has elapsed after sending a key update start notification, key replacing section 120 sends a key update end notification to encryption section 130 and decoding section 140 reporting that the predetermined time has elapsed. The predetermined time from sending a key update start notification to sending a key update end notification can be set arbitrarily, but should be a sufficient length of time for an apparatus (mobile communication terminal apparatus 100) and the communicating-party apparatus (wireless base station 200) to install an encryption key. By this means, key replacing section 120 can send a key update end notification to decoding section 140 after both apparatuses have finished installing the encryption key.

Encryption section 130 holds an encryption key, encrypts user data using the encryption key, and transmits generated encrypted data to wireless base station 200. When notified of a new encryption key by key replacing section 120, encryption section 130 updates an old encryption key used theretofore to the new encryption key of which it has been notified.

Decoding section 140 holds an encryption key, and generates user data by decoding encrypted data transmitted from wireless base station 200 using the encryption key. When notified of a new encryption key by key replacing section 120, decoding section 140 updates an old encryption key used theretofore to the new encryption key, and also stores the old encryption key in key storing section 150. Decoding section 140 always performs decoding using the latest encryption key it holds, but if the encryption key does not match and decoding is not possible, decoding section 140 tries decoding using the old encryption key stored in key storing section 150. Moreover, if decoding section 140 cannot perform decoding using the old encryption key while encryption key updating is being performed (in the interval between receiving a key update start notification and receiving a key update end notification), it discards encrypted data that cannot be decoded. On receiving a key update end notification from key replacing section 120, decoding section 140 instructs key storing section 150 to discard the stored old encryption key.

When instructed to store an old encryption key by decoding section 140, key storing section 150 stores the old encryption key of which it has been notified. Also, when instructed to discard an old encryption key by decoding section 140, key storing section 150 discards the old encryption key that it was storing.

Wireless base station 200 is configured by means of key update management section 210, key replacing section 220, encryption section 230, decoding section 240, and key storing section 250.

Key update management section 210 manages the life-span of encryption keys possessed by encryption section 230 and decoding section 240. On detecting that the life-span of these encryption keys has expired, key update management section 210 instructs key replacing section 220 to perform encryption key updating.

When instructed to perform encryption key updating by key update management section 210, or on receiving a random number (SNonce) for encryption key updating from mobile communication terminal apparatus 100, key replacing section 220 sends a key update start notification to encryption section 230 and decoding section 240, and then generates an encryption key by performing a 4-way handshake with mobile communication terminal apparatus 100. After finishing the 4-way handshake, key replacing section 220 notifies encryption section 230 and decoding section 240 of the new encryption key, and has them update to the new key. Also, when a predetermined time has elapsed after sending a key update start notification to encryption section 230 and decoding section 240, key replacing section 220 sends a key update end notification to encryption section 230 and decoding section 240. The predetermined time from sending a key update start notification to sending a key update end notification can be set arbitrarily, but should be a sufficient length of time for an apparatus (wireless base station 200) and the communicating-party apparatus (mobile communication terminal apparatus 100) to install an encryption key. By this means, key replacing section 220 can send a key update end notification to decoding section 240 after both apparatuses have finished installing the encryption key.

Encryption section 230 holds an encryption key, encrypts user data using the encryption key, and transmits generated encrypted data to mobile communication terminal apparatus 100. When notified of a new encryption key by key replacing section 220, encryption section 230 updates an old encryption key used theretofore to the new encryption key of which it has been notified.

Decoding section 240 holds an encryption key, and generates user data by decoding encrypted data transmitted from mobile communication terminal apparatus 100 using the encryption key. When notified of a new encryption key by key replacing section 220, decoding section 240 updates an old encryption key used theretofore to the new encryption key, and also stores the old encryption key in key storing section 250. Decoding section 240 always performs decoding using the latest encryption key it holds, but if the encryption key does not match and decoding is not possible, decoding section 240 tries decoding using the old encryption key stored in key storing section 250. Moreover, if decoding section 240 cannot perform decoding using the old encryption key while encryption key updating is being performed (in the interval between receiving a key update start notification and receiving a key update end notification), it discards encrypted data that cannot be decoded. On receiving a key update end notification from key replacing section 220, decoding section 240 instructs key storing section 250 to discard the stored old encryption key.

When instructed to store an old encryption key by decoding section 240, key storing section 250 stores the old encryption key of which it has been notified. Also, when instructed to discard an old encryption key by decoding section 240, key storing section 250 discards the old encryption key that it was storing.

The operation of mobile communication terminal apparatus 100 and wireless base station 200 configured as described above will now be explained.

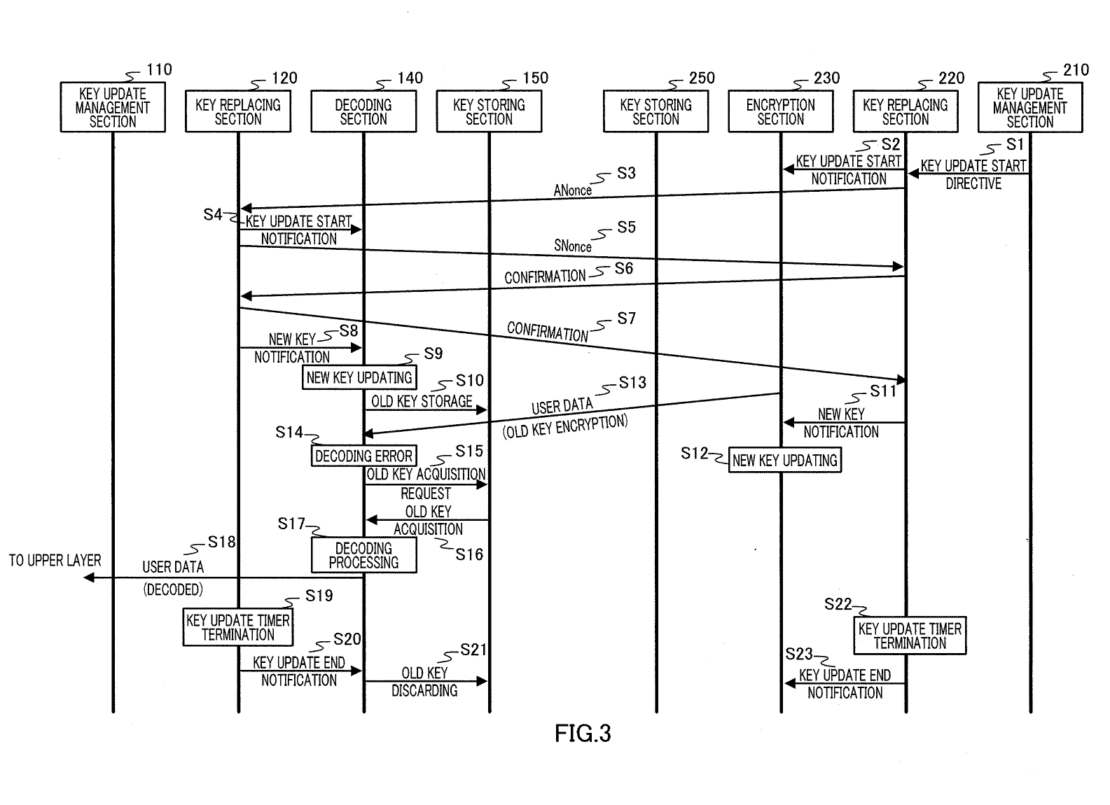

FIG. 3 is a control sequence diagram showing the operation of mobile communication terminal apparatus 100 and wireless base station 200 when encryption key updating is performed between mobile communication terminal apparatus 100 and wireless base station 200. FIG. 3 shows an example in which mobile communication terminal apparatus 100 and wireless base station 200 update a PTK as an encryption key, and shows an example in which wireless base station 200 transmits encrypted data to mobile communication terminal apparatus 100 during the occurrence of encryption key mismatching. It is assumed that mobile communication terminal apparatus 100 and wireless base station 200 share a PMK that is an item that generates a PTK.

First, in wireless base station 200, key update management section 210 detects that the PTK life-span has expired, and sends a key update start directive to key replacing section 220 (step S1). On receiving the key update start directive, key replacing section 220 sends a key update start notification to encryption section 230 and decoding section 240 (not shown) (step S2). Then key replacing section 220 generates an ANonce, and transmits the generated ANonce to key replacing section 120 of mobile communication terminal apparatus 100 (step S3).

In mobile communication terminal apparatus 100, key replacing section 120, on receiving the ANonce, sends a key update start notification to encryption section 130 (not shown) and decoding section 140 (step S4), and generates an SNonce. Then key replacing section 120 generates a PTK from the generated SNonce, the received ANonce, and a PMK it holds, transmits the generated SNonce to key replacing section 220 of wireless base station 200 (step S5).

In wireless base station 200, key replacing section 220, on receiving the SNonce, generates a PTK from the generated ANonce, the received SNonce, and a PMK it holds, and transmits a PTK installation confirmation message to key replacing section 120 of mobile communication terminal apparatus 100 (step S6).

In mobile communication terminal apparatus 100, key replacing section 120, on receiving the confirmation message, transmits a PTK installation confirmation message to the wireless base station (step S7). Then key replacing section 120 notifies encryption section 130 (not shown) and decoding section 140 of the generated PTK (hereinafter referred to as “new key”) (step S8). On being notified of the new key, encryption section 130 (not shown) and decoding section 140 update the PTKs they respectively hold to the new key (step S9). At this time, decoding section 140 stores the PTK held theretofore (hereinafter referred to as “old key”) in key storing section 150 (step S10).

Similarly, in wireless base station 200, key replacing section 220, on receiving a confirmation message, notifies encryption section 230 and decoding section 240 (not shown) of the new key (step S11). On being notified of the new key, encryption section 230 and decoding section 240 (not shown) update the PTKs they respectively hold to the new key (step S12). At this time, decoding section 240 stores the old key in key storing section 250 (not shown).

By means of the processing in above step Si through step S12, mobile communication terminal apparatus 100 and wireless base station 200 can each update an encryption key to a new key, but in the interval from above step S9 through step S12 encryption key mismatching occurs between mobile communication terminal apparatus 100 and wireless base station 200. That is to say, in the interval from above step S9 through step S12, encryption section 130 and decoding section 140 have finished updating to the new key in mobile communication terminal apparatus 100, but encryption section 230 and decoding section 440 have not finished updating to the new key in wireless base station 200. FIG. 3 shows an example of a case in which wireless base station 200 transmits encrypted data to mobile communication terminal apparatus 100 during this occurrence of encryption key mismatching (during the interval from above step S9 through step S12).

During the occurrence of encryption key mismatching (during the interval from above step S9 through step S12), encryption section 230 in wireless base station 200 encrypts user data using the old key, and transmits the generated encrypted data to decoding section 140 of mobile communication terminal apparatus 100 (step S13).

In mobile communication terminal apparatus 100, decoding section 140 tries decoding the received encrypted data using the new key, but since the encrypted data was encrypted using the old key, a decoding error occurs (step S14). When the decoding error occurs, decoding section 140 sends an old key acquisition request to key storing section 150 in order to acquire the old key stored in key storing section 150 in step S10 (step S15). On receiving this old key acquisition request, key storing section 150 notifies decoding section 140 of the stored old key (step S16). By using the old key of which it has been notified, decoding section 140 can decode the encrypted data received in step S13 (step S17). The decoded user data is passed to an upper layer not shown in the figure (step S18). If decoding section 140 is unable to decode the encrypted data in step S17 despite using the old key, it does not perform disconnection processing but discards the encrypted data that it cannot decode.

In mobile communication terminal apparatus 100, when a predetermined time has elapsed after sending of a key update start notification to encryption section 130 and decoding section 140 by key replacing section 120, key replacing section 120 detects that the predetermined time has elapsed (step S19), and sends a key update end notification to encryption section 130 (not shown) and decoding section 140 (step S20). On receiving this key update end notification, decoding section 140 discards the old key stored in key storing section 150 (step S21).

Similarly, in wireless base station 200, when a predetermined time has elapsed after sending of a key update start notification to encryption section 230 and decoding section 240 by key replacing section 220, key replacing section 220 detects that the predetermined time has elapsed (step S22), and sends a key update end notification to encryption section 230 and decoding section 240 (not shown) (step S23). On receiving this key update end notification, decoding section 240 discards the old key stored in key storing section 250 (not shown).

By means of the above procedure, mobile communication terminal apparatus 100 can decode encrypted data transmitted in a downward direction even during the occurrence of encryption key mismatching.

As described above, by storing an old key used theretofore in a key storing section when updating an encryption key, a wireless communication apparatus according to Embodiment 1 can decode even data transmitted during the occurrence of encryption key mismatching by using the stored old key, enabling interruptions in speech, image, or suchlike real-time traffic to be reduced, and enabling resulting noise perceived by a user to be reduced.

Also, when a wireless communication apparatus according to Embodiment 1 is unable to decode received data even by using an old encryption key stored by a key storing section while performing encryption key updating, the wireless communication apparatus discards that received data while maintaining a connection to a communicating-party apparatus. By this means, a wireless communication apparatus according to Embodiment 1 can maintain a connection to a communicating-party apparatus despite the occurrence of a decoding error due to encryption key updating.

### Embodiment 2

In Embodiment 1, an example was shown in which a wireless base station transmits encrypted data to a mobile communication terminal apparatus during the occurrence of encryption key mismatching (downward data transmission). In Embodiment 2, an example is shown in which a mobile communication terminal apparatus transmits encrypted data to a wireless base station during the occurrence of encryption key mismatching (upward data transmission).

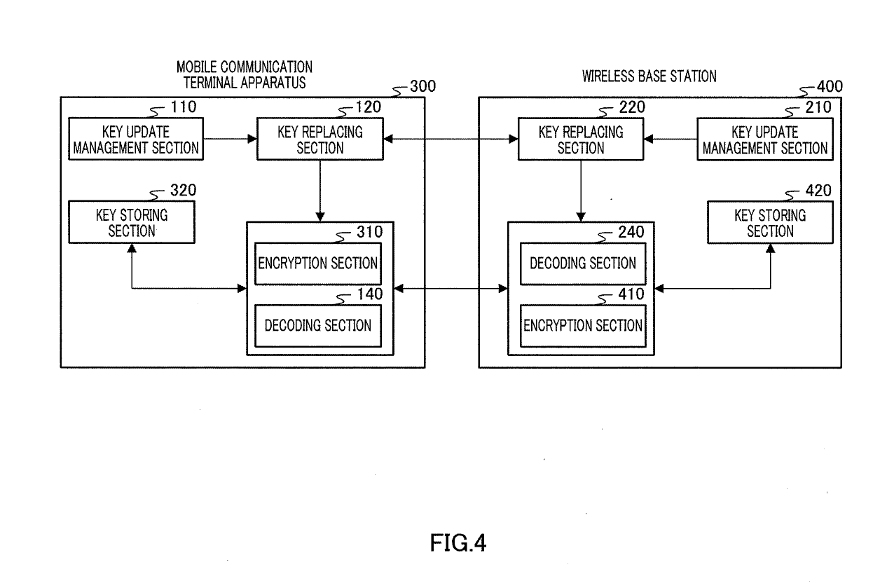

FIG. 4 is a block diagram showing configurations of wireless communication apparatuses of Embodiment 2 of the present invention. Configuration elements identical to those of a mobile communication terminal apparatus and wireless base station according to Embodiment 1 are assigned the same reference codes as in Embodiment 1, and descriptions thereof are omitted here.

Mobile communication terminal apparatus 300 is configured by means of key update management section 110, key replacing section 120, encryption section 310, decoding section 140, and key storing section 320.

In the same way as encryption section 130 of Embodiment 1, encryption section 310 encrypts user data using an encryption key, and transmits generated encrypted data to wireless base station 400. When notified of a new encryption key by key replacing section 120, encryption section 310 stores the new encryption key of which it has been notified in key storing section 320, and on receiving a key update end notification from key replacing section 120, encryption section 310 updates an old encryption key used theretofore to the new encryption key stored in key storing section 320. That is to say, encryption section 310 performs user data encryption using the old encryption key until it receives a key update end notification from key replacing section 120.

In addition to the function of key storing section 150 of Embodiment 1, key storing section 320 also stores a new encryption key of which notification has been given when an instruction to store a new encryption key is given by encryption section 310. When encryption section 310 is notified of a new encryption key, key storing section 320 may, but need not, discard this key.

Wireless base station 400 is configured by means of key update management section 210, key replacing section 220, encryption section 410, decoding section 240, and key storing section 420.

In the same way as encryption section 230 of Embodiment 1, encryption section 410 encrypts user data using an encryption key, and transmits generated encrypted data to mobile communication terminal apparatus 300. When notified of a new encryption key by key replacing section 220, encryption section 410 stores the new encryption key of which it has been notified in key storing section 420, and on receiving a key update end notification from key replacing section 220, encryption section 410 updates an old encryption key used theretofore to the new encryption key stored in key storing section 420. That is to say, encryption section 410 performs user data encryption using the old encryption key until it receives a key update end notification from key replacing section 220.

In addition to the function of key storing section 250 of Embodiment 1, key storing section 420 also stores a new encryption key of which notification has been given when an instruction to store a new encryption key is given by encryption section 410. When encryption section 410 is notified of a new encryption key, key storing section 420 may, but need not, discard this key.

The operation of mobile communication terminal apparatus 300 and wireless base station 400 configured as described above will now be explained.

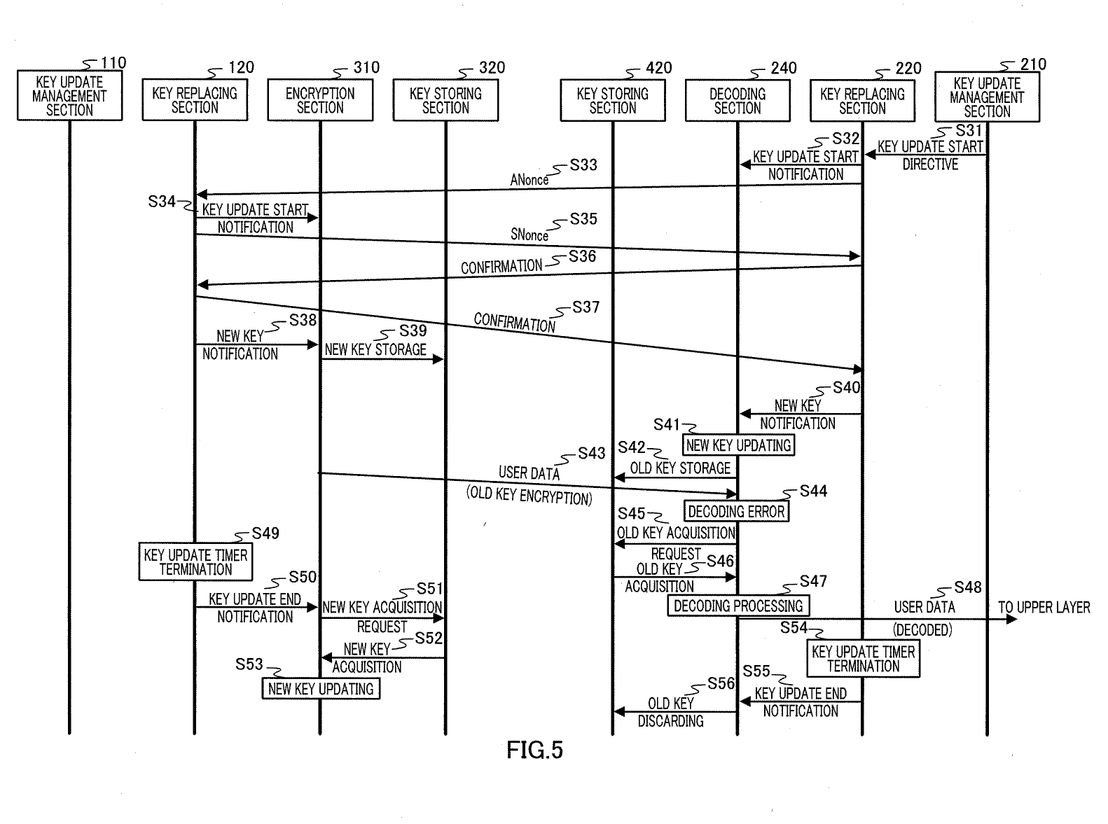

FIG. 5 is a control sequence diagram showing the operation of mobile communication terminal apparatus 300 and wireless base station 400 when encryption key updating is performed between mobile communication terminal apparatus 300 and wireless base station 400. An example is shown here in which mobile communication terminal apparatus 300 and wireless base station 400 update a PTK as an encryption key, and an example is shown in which mobile communication terminal apparatus 300 transmits encrypted data to wireless base station 400. It is assumed that mobile communication terminal apparatus 300 and wireless base station 400 share a PMK.

Step S31 through step S37 are similar to step Si through step S7 in FIG. 31. That is to say, first, in wireless base station 400, key update management section 210 detects that the PTK life-span has expired, and sends a key update start directive to key replacing section 220 (step S31). On receiving the key update start directive, key replacing section 220 performs a 4-way handshake with key replacing section 120 of mobile communication terminal apparatus 300, and key replacing section 220 and key replacing section 120 each generate a PTK (steps S32 through S37).

Then, in mobile communication terminal apparatus 300, key replacing section 120 notifies encryption section 310 and decoding section 140 (not shown) of the generated PTK (new key) (step S38). On being notified of the new key, decoding section 140, in the same way as in step S9 in FIG. 3, updates the held PTK to the new key, and stores the PTK (old key) held theretofore in key storing section 320 (not shown). Meanwhile, on being notified of the new key, encryption section 310 does not update the held PTK to the new key, but stores the new key of which it has been notified directly in key storing section 320 (step S39).

Similarly, in wireless base station 400, key replacing section 220 notifies encryption section 410 (not shown) and decoding section 240 of the new key (step S40). On being notified of the new key, decoding section 240 updates the held PTK to the new key (step S41), and stores the old key in key storing section 420 (step S42). Meanwhile, on being notified of the new key, encryption section 410 does not update the held PTK to the new key, but stores the new key of which it has been notified directly in key storing section 420 (not shown).

Thus, when step S41 is finished, encryption sections 310 and 410 are in a state in which they hold an old key (a pre-key-updating state), and decoding sections 140 and 240 are in a state in which they hold a new key (a post-key-updating state). In this state, encryption key mismatching occurs both when wireless base station 400 transmits encrypted data to mobile communication terminal apparatus 300, and also when mobile communication terminal apparatus 300 transmits encrypted data to wireless base station 400. That is to say, when wireless base station 400 transmits encrypted data to mobile communication terminal apparatus 300, encryption section 410 of wireless base station 400 encrypts user data with the old key, and decoding section 140 of mobile communication terminal apparatus 300 decodes encrypted data with the new key, and therefore encryption key mismatching occurs. Similarly, when mobile communication terminal apparatus 300 transmits encrypted data to wireless base station 400, encryption section 310 of mobile communication terminal apparatus 300 encrypts user data with the old key, and decoding section 240 of wireless base station 400 decodes encrypted data with the new key, and therefore encryption key mismatching occurs. FIG. 5 shows an example of a case in which mobile communication terminal apparatus 300 transmits encrypted data to wireless base station 400 during such an occurrence of encryption key mismatching (during the interval from step S41 through step S53 described later herein).

During the occurrence of encryption key mismatching, encryption section 310 iii mobile communication terminal apparatus 300 encrypts user data using the old key, and transmits the generated encrypted data to decoding section 240 of wireless base station 400 (step S43).

In wireless base station 400, decoding section 240 tries decoding the received encrypted data using the new key, but since the encrypted data was encrypted using the old key, a decoding error occurs (step S44). When the decoding error occurs, decoding section 240 sends an old key acquisition request to key storing section 420 in order to acquire the old key stored in key storing section 420 in step S42 (step S45). On receiving this old key acquisition request, key storing section 420 notifies decoding section 240 of the stored old key (step S46). By using the old key of which it has been notified, decoding section 240 can decode the encrypted data received in step S43 (step S47). The decoded user data is passed to an upper layer not shown in the figure (step S48). If decoding section 240 is unable to decode the encrypted data in step S47 despite using the old key, it does not perform disconnection processing but discards the encrypted data that it cannot decode.

In mobile communication terminal apparatus 300, when a predetermined time has elapsed after sending of a key update start notification to encryption section 310 and decoding section 140 by key replacing section 120, key replacing section 120 detects that the predetermined time has elapsed (step S49), and sends a key update end notification to encryption section 310 and decoding section 140 (step S50). On receiving this key update end notification, encryption section 310 sends a new key acquisition request to key storing section 320 in order to acquire the new key stored in key storing section 320 in step S39 (step S51). On receiving this new key acquisition request, key storing section 320 notifies encryption section 310 of the stored new key (step S52). On being notified of the new key, encryption section 310 updates the held PTK to the new key (step S53). Meanwhile, on receiving a key update end notification, decoding section 140 discards the old key stored in key storing section 320 (not shown).

Similarly, in wireless base station 400, when a predetermined time has elapsed after sending of a key update start notification to encryption section 410 and decoding section 240 by key replacing section 220, key replacing section 220 detects that the predetermined time has elapsed (step S54), and sends a key update end notification to encryption section 410 and decoding section 240 (step S55). On receiving this key update end notification, encryption section 410 sends a new key acquisition request to key storing section 420. On receiving this new key acquisition request, key storing section 420 notifies encryption section 410 of the stored new key. On being notified of the new key, encryption section 410 updates the held PTK to the new key (not shown). Meanwhile, on receiving a key update end notification, decoding section 240 discards the old key stored in key storing section 420 (step S56). When a 4-way handshake is started by wireless base station 400, it is desirable for key replacing section 120 and 220 timers (predetermined times) to be set so that key replacing section 220 of wireless base station 400 can send a key update end notification (step S55) after key replacing section 120 of mobile communication terminal apparatus 300 sends a key update end notification (step S50). The reason for this is that, if key replacing section 220 of wireless base station 400 sends a key update end notification before key replacing section 120 of mobile communication terminal apparatus 300 sends a key update end notification, there is a possibility of decoding section 240 of wireless base station 400 not being able to decode encrypted data.

By means of the above procedure, mobile communication terminal apparatus 300 and wireless base station 400 can decode not only encrypted data transmitted in a downward direction but also encrypted data transmitted in an upward direction during the occurrence of encryption key mismatching.

During the interval from above step S38 through step S41, encryption section 310 of mobile communication terminal apparatus 300 and encryption section 410 and decoding section 240 of wireless base station 400 are in a state in which they hold an old key (a pre-key-updating state), and only decoding section 140 of mobile communication terminal apparatus 300 is in a state in which it holds a new key (a post-key-updating state). In this state, encryption key mismatching occurs only when wireless base station 400 transmits encrypted data to mobile communication terminal apparatus 300. In this case, decoding section 140 of mobile communication terminal apparatus 300 can perform decoding by using the old key stored in key storing section 420, in the same way as in Embodiment 1 (see steps S14 through S17).

As described above, in Embodiment 2 provision is made for user data to be encrypted using an old key even after a new key has been generated while encryption key updating is being performed. By this means, in addition to achieving the effects of Embodiment 1, a wireless communication apparatus according to Embodiment 2 can decode data even if a wireless communication apparatus that first generates an encryption key (the mobile communication terminal apparatus in FIG. 5) transmits encrypted data to a wireless communication apparatus that later generates an encryption key (the wireless base station in FIG. 5) during the occurrence of encryption key mismatching.

In the above embodiments, examples have been described in which the present invention is applied to a wireless LAN, but the present invention is not limited to a wireless LAN, and can be applied to a system in which an encryption key is updated by means of an asynchronous wireless communication method.

Also, in the above embodiments, examples have been described in which encryption key updating by means of a 4-way handshake is started by a wireless base station, but encryption key updating by means of a 4-way handshake may also be started by a mobile communication terminal apparatus.

### INDUSTRIAL APPLICABILITY

A wireless communication apparatus and encryption key updating method of the present invention are suitable for use in updating of an encryption key between apparatuses in a wireless LAN or suchlike asynchronous wireless communication system.

1. A wireless communication apparatus comprising:
a key replacing section that updates an encryption key at predetermined timing;
a key storing section that stores a pre-updating encryption key when said key replacing section updates said encryption key; and
a decoding section that decodes received data using a latest encryption key, and if a decoding error occurs, decodes that received data using an encryption key stored by said key storing section.

2. The wireless communication apparatus according to claim 1, wherein said key replacing section sends a key update start notification to said decoding section when updating said encryption key, and, when a predetermined time has elapsed after said notification, sends a key update end notification to said decoding section.

3. The wireless communication apparatus according to claim 2, wherein said decoding section, if unable to decode said received data using said latest encryption key in an interval from receiving said key update start notification to receiving said key update end notification, decodes that received data using said encryption key stored by said key storing section.

4. The wireless communication apparatus according to claim 3, wherein said key replacing section, if unable to decode said received data using said encryption key stored by said key storing section in an interval from receiving said key update start notification to receiving said key update end notification, discards that received data.

5. The wireless communication apparatus according to claim 2, wherein said key storing section further discards stored said encryption key when said key replacing section sends said key update end notification to said decoding section.

6. The wireless communication apparatus according to claim 2, further comprising an encryption section that encrypts transmission data using an encryption key, wherein:
said key replacing section further sends said key update end notification to said encryption section; and
said encryption section, on receiving said key update end notification, performs encryption using said latest encryption key.

7. The wireless communication apparatus according to claim 1, wherein said key replacing section generates an encryption key by performing a 4-way handshake with another communication apparatus.

8. A decoding method comprising:
a step of updating an encryption key at predetermined timing;
a step of storing a pre-updating encryption key;
a step of decoding received data using a latest encryption key; and
a step of, if a decoding error occurs, decoding that received data using stored said pre-updating encryption key.
